(19) United States
(12) Patent Application Publication
(10) Pub. No.: US 2010/0194556 A1
(43) Pub. Date: Aug. 5, 2010

(54) ELECTRONIC LIGHTBAR WARNING DEVICE AND METHOD OF USE THEREOF

(76) Inventor: Tom F. LaRosa, Voorheesville, NY (US)

Correspondence Address: SCHMEISER OLSEN & WATTS, 18 E UNIVERSITY DRIVE, SUITE # 101, MESA, AZ, 85201, US

(21) Appl. No.: 12/700,107

(22) Filed: Feb. 4, 2010

Related U.S. Application Data
(60) Provisional application No. 61/150,075, filed on Feb. 5, 2009.

(51) Int. Cl. B60Q 1/52; G09F 9/33; G08B 5/22

(52) U.S. Cl. 340/471; 340/815.45; 340/825.36

(57) ABSTRACT

A warning device comprising a lightbar, a programmable chip for controlling LED lights, a controller, and a rechargeable battery. The lightbar is removably coupled to the emergency vehicle or another object such as a road block, where a dangerous situation exists, to warn persons of a hazard. Rechargeable batteries are recharged by solar panels on the lightbar. Rechargeable batteries are used to power the warning device. The programmable chip for controlling the LED is linked wirelessly to the controller, a remote control. The lightbar may be activated by a remote control from inside or outside the vehicle or from a base station to perform a variety of tasks. Warnings may be transmitted from the lightbar using visual and audio signals. Visual signals may include flashing at various speeds and intensities in various colors, text messages and other warning signals to advise persons of dangers in an effort to promote safety.

### CROSS-REFERENCE TO RELATED PATENT APPLICATIONS

This patent application claims the benefit of priority to U.S. Provisional Patent Application No. 61/150,075, filed Feb. 5, 2009, and entitled, “Lightbar Systems,” which is incorporated in its entirety herein by reference.

### BACKGROUND OF THE INVENTION

1. Field of the Invention

The present invention relates generally to the field of lighting and more specifically relates to remote-controlled lightbars which can be used particularly for emergency vehicles.

2. Description of the Related Art

Emergency lighting is required in many situations to provide warnings or notice to individuals, vehicles and the like of any dangerous situations that may be present. Lighting systems may be hardwired into emergency vehicles creating a large demand for electrical power whereby alternators and batteries may experience decreased efficiency in operation and diminished longevity. Further, inefficiencies of hardwired lighting systems in use may cause excessive idling of vehicles leading to unnecessary burning of fossil fuels thereby damaging the environment and creating a danger to persons operating those vehicles. In addition, should a hardwired system fail the entire vehicle must often be taken out of service until repairs can be made. In an effort to compensate for large electric loads being placed on the vehicle, vehicles may be required to be equipped with higher horsepower motors, which may lead to increased maintenance and decreased reliability.

Hardwired lighting systems may also occupy a substantial volume as wires are routed through and subsequently concealed in vehicles. Problems exist when attempting to pass wires through congested areas such as doors and headliners. It is difficult, time-consuming, expensive and labor-intensive to run wires past items such as side curtain air bags, and to drill access holes in roofs. Wires may impede the proper operation of air bags and other such accessories causing undue danger to drivers and occupants of these vehicles. Vehicles with access holes in roofs, permitting wiring to pass from the interior to the exterior, may experience lower resale rates and/or alternatively further labor expenditures to conceal such holes after the vehicle is surplused. Lighting systems of this nature do not lend themselves to portable usage due to the method by which they are mounted and wired. Further, bulky control heads to operate such systems may limit valuable interior space of the vehicle.

Ideally, a lighting system should require minimal power demand, be portable, yet operate reliably and be cost-effective to manufacture, install and maintain. Thus, a need exists for a reliable portable emergency lighting system to avoid the above-mentioned problems.

### BRIEF SUMMARY OF THE INVENTION

A warning device is described herein comprising a lightbar, a programmable chip for controlling LED lights, a controller, and one or more rechargeable batteries. The lightbar is removably coupled to the emergency vehicle for use where a dangerous situation exists to warn persons of the hazard. Rechargeable batteries may be recharged by solar panels on the lightbar and are used to power the warning device. The programmable chip for controlling the LED is linked wirelessly to the controller, a remote control. The lightbar may be activated by a remote control from inside or outside the vehicle to perform a variety of tasks. Warnings may be transmitted from the lightbar using visual and audio signals. By being capable of remote activation an individual, such as a police officer, after exiting the vehicle and encountering a dangerous situation can call for backup and then activate the light bar to aid other officers in locating the vehicle. Visual signals may include flashing at various speeds and intensities in various colors, text messages and other warning signals to advise persons of present dangers.

The present invention holds significant improvements and serves as an emergency lighting system. These and other features, aspects, and advantages of the present invention will become better understood with reference to the following drawings and description.

### BRIEF DESCRIPTION OF THE DRAWINGS

The embodiments of the present invention will hereinafter be described in conjunction with the appended drawings, wherein like designations denote like elements.

FIG. 1 shows a perspective view, illustrating an emergency lighting system in use on an emergency vehicle, according to an embodiment of the present invention.

FIG. 2 is a perspective view illustrating the emergency lighting system according to an embodiment of the present invention of FIG. 1.

FIG. 3 is an exploded view illustrating the emergency lighting system according to an embodiment of the present invention of FIG. 1.

FIG. 4 is a flowchart illustrating a method of use for the emergency lighting system according to an embodiment of the present invention of FIG. 1.

FIG. 5 is a flowchart illustrating a method of use for the emergency lighting system according to an embodiment of the present invention of FIG. 1.

FIG. 6 is a flowchart illustrating a method of use for the emergency lighting system according to an embodiment of the present invention of FIG. 1.

### DETAILED DESCRIPTION

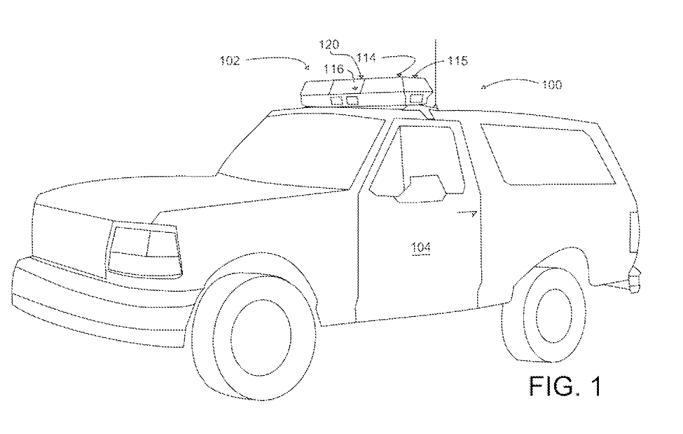

Referring now to FIG. 1, showing a perspective view, illustrating emergency lighting system 100 in use on emergency vehicle 104, according to an embodiment of the present invention.

Emergency vehicle 104 lighting may utilize several visual warning devices, which may include at least one light bar 102 and/or at least one beacon, fitted to at least one emergency vehicle 104. Emergency lighting system 100 is designed to be a warning device used when a driver of an emergency vehicle 104 wishes to convey to other road users the urgency of their journey, to provide at least one warning of at least one hazard when stationary, or in the case of law enforcement as a means of signaling at least one driver to stop for at least one interaction with at least one officer, or serving as a location or status system.

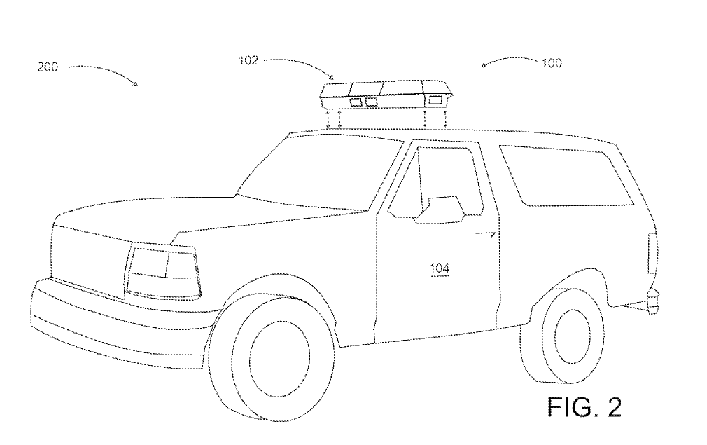

Emergency lighting system 100 preferably comprises at least one light bar 102, as shown, which may or may not be used in combination with sirens in order to maximize its effectiveness. In many jurisdictions, the use of light bars 102 may afford the user specific legal powers, and may place requirements on other road users to behave differently, such as compelling them to pull to the side of the road and/or yield right of way so emergency vehicle 104 may proceed through at maximum speed. Emergency lighting system 100 preferably illuminates emergency vehicle 104 or other object, as shown in FIG. 2, to provide at least one warning notification to persons within visual range.

Preferably, emergency lighting system 100 is portable and may be removably coupled to emergency vehicle 104 or a road block at the location of the emergency vehicle 104. Indeed, emergency lighting system 100 may be repeatedly detached from and coupled to an emergency vehicle 104 or other structure at the location of the emergency vehicle 104. Emergency lighting system 100 may operate independently of the emergency vehicle 104 and receive power separately from the emergency vehicle 104.

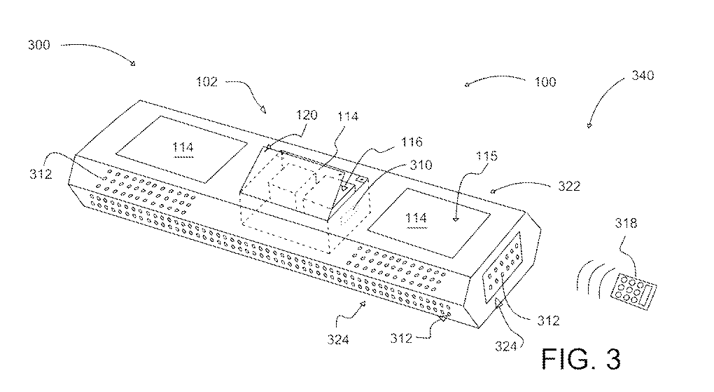

Emergency lighting system 100 is preferably powered via at least one rechargeable battery 116, more specifically emergency lighting system 100 is preferably powered by at least two rechargeable batteries 116, as shown in FIG. 3. The use of rechargeable battery 116 permits lightbar 102 to operate independent of emergency vehicle 104 since it has its own power source. If desired, rechargeable batteries 116 for emergency lighting system 100 may be hardwired to emergency vehicle 104 to provide an optional back up power supply.

A plurality of rechargeable batteries 116 can be used in an embodiment of the present invention, especially considering that one of the plurality of rechargeable batteries 116 could fail or lose its charge. Having a plurality of rechargeable batteries 116 it is possible to have at least one redundant backup to maintain power in emergency situations. Preferably, a notification may be activated if one of rechargeable batteries 116 fails and a backup rechargeable battery 116 is required. Preferably, rechargeable battery 116 is charged and recharged upon demand by at least one solar panel 114, thereby sustaining an independently powered emergency lighting system 100.

Emergency lighting system 100 preferably comprises at least two solar panels 114, preferably mounted flat on the upper horizontal surface portion of lightbar 102, as also shown in FIG. 3. Solar panels 114 are preferably mounted in the horizontal position for ease of manufacture, for aesthetics, to minimize wind resistance when emergency vehicle 104 is in motion and to maximize efficiency of solar ray collection. Further, using the preferred upper horizontal surface position, available lighting area on vertical surfaces of lightbar 102 may be maximized. Upon reading this specification, those with ordinary skill in the art will now appreciate that, under appropriate circumstances, considering such issues as design preference, user preferences, marketing preferences, cost, structural requirements, available materials, technological advances, etc., other solar panel positioning and arrangements such as, for example, solar panels placed on the vehicle roof, on different positions on the lightbar, on the hood or trunk, translucent panels placed on vertical portions of the lightbar, solar panels that move to follow the sun, and solar panel(s) mounted in remote locations, etc., may be used.

Solar panel 114 is preferably used to convert solar energy into electricity via at least one photovoltaic effect. Solar panels 114 preferably comprise an interconnected assembly of photovoltaic (solar) cells 115. Solar cells 115 are preferably connected electrically and packaged in at least one photovoltaic module. The modules according to the preferred embodiment of the present invention preferably comprise wafer-based crystalline silicon cells or alternately preferably, thin film cell based on cadmium telluride or silicon. The modules are preferably mechanically fastened together, wired, and designed to comprise at least one portable unit, with a glass and/or plastic covering with or without at least one frame to provide protection from moisture and potential impact damage from the environment.

Electrical connections in solar panels 114 are preferably made in series to achieve a desired output voltage and/or alternately preferably, in parallel to provide at least one desired amount of current source capability, depending on application. It should also be noted that the various wiring combinations as described herein with emergency lighting system 100 is for purposes of illustration only and other suitable means of wiring the various components of emergency lighting system 100 may be employed.

Preferably, a plurality of diodes is included to avoid overheating of solar cells 115 thereby providing cooling in hot environments. Within the preferred embodiment of the present invention solar panels 114 may be rearwardly hinged and mounted solid to lightbar 102 via at least one fastener 120 or by other suitable attaching means, thereby providing a means whereby rechargeable batteries 116 can be removed for at least one of maintenance and replacement. Hinges are preferably placed in the leading edge of lightbar 102 so that in the event that fasteners 120 aren't properly tightened that the wind will not force solar panels 114 open, potentially ruining solar panels 114. Those with ordinary skill in the art will now appreciate that upon reading this specification and by their understanding the art of solar panels as described herein, methods of solar energy collection will be understood by those knowledgeable in such art. Upon reading this specification, those with ordinary skill in the art will now appreciate that, under appropriate circumstances, considering such issues as design preference, user preferences, marketing preferences, cost, structural requirements, available materials, technological advances, etc., other fastening arrangements such as, for example, snaps, clips, various types of hinges, ties, magnets, no fasteners, and fasteners at different locations, etc., may be used.

Preferably, emergency lighting system 100 is internally wired within housing 322 of lightbar 102, as shown in FIG. 3. Emergency lighting system 100 preferably requires substantially no external wires to be connected to the power source of emergency vehicle 104, thereby saving extensive labor expenses and logistics problems while routing wiring. Emergency lighting system 100 doesn't require power from emergency vehicle 104 thereby providing greater versatility for the present invention. Further, because emergency lighting system 100 requires no electrical connection to the power source of emergency vehicle 104, substantially no interference is induced with items such as deployable side curtain air bags. Emergency lighting system 100 is designed to create no additional electric load on emergency vehicle 104, thereby not reducing alternator and battery lifespan due to added service demand.

Emergency vehicles 104 may have their ignitions shut off during non-travel times while still operating light bar 102 since light bar 102 is not creating a power drain on the battery of emergency vehicles 104. As a result emergency vehicles 104 will not burn as much fuel thereby reducing environmental impact and provide a means of increasing public safety by not requiring emergency vehicle 104 to be running left unattended. Within the preferred embodiment of the present invention bulky control heads may be substantially eliminated thereby avoiding further limitations to interior space of emergency vehicles 104.

Preferably, emergency lighting system 100 is remotely controlled by at least one controller, more specifically a remote control 318 from inside or outside of emergency vehicle 104. Preferably, remote control 318 is linked wirelessly to programmable chip 310. Those with ordinary skill in the art will now appreciate that upon reading this specification and by their understanding the art of remote controllers and wireless linking as described herein, methods of remote control and wireless linking will be understood by those knowledgeable in such art.

The use of remote control 318 allows a variety of options to the user and saves valuable interior space as a further benefit. For example, a first officer, while out of emergency vehicle 104, may use remote control 318 to activate spotlight 324 or, by flashing lights on lightbar 102, to aid in the search for at least one suspect and/or allow a second officer to locate the vicinity of the first officer as a means of communication or other such options. Spotlight 324 may also be remotely focused on at least one victim if used by EMS or other such emergency vehicle 104. Upon reading this specification, those with ordinary skill in the art will now appreciate that, under appropriate circumstances, considering such issues as design preference, user preferences, marketing preferences, cost, structural requirements, available materials, technological advances, etc., other remote control options and arrangements such as, for example, sending text or visual messages such as Morse code to communicate with another officer(s) or suspect(s), messages may be codes or non-codes, messages may be displayed or not displayed on lightbar or remote control, etc., may suffice.

Also, for example, the remote control 318 may be used by a base station operator to aid an officer that has become temporarily disabled or inhibited for any reason. For example, when a first officer is away from his/her emergency vehicle in pursuit of a suspect and gets hurt or detained, the officer may radio to the base station for help. In response, the operator may remotely active, for example, the flashing lights or the visual text message on the lightbar 102 to assist others in finding or helping the first officer. The visual text or flashing lights on the lightbar 102 may also serve to alert the public of the ongoing disturbance or dangerous situation and either warn the public to stay away or ask the public for assistance.

Referring now to FIG. 2, showing perspective view 200 illustrating emergency lighting system 100, according to a preferred embodiment of the present invention of FIG. 1.

FIG. 2 illustrates how lightbar 102 of emergency lighting system 100 may be preferably removably coupled to emergency vehicle 104. Lightbar 102 may be coupled via at least one coupler that may include magnets, adhesives, tapes or by other such suitable attaching means. Lightbar 102 is preferably self-contained, independently powered and portable. Upon reading this specification, those with ordinary skill in the art will now appreciate that, under appropriate circumstances, considering such issues as design preference, user preferences, marketing preferences, cost, structural requirements, available materials, technological advances, etc., other removable coupling arrangements such as, for example, suctioning cups, hook and loop configurations, snaps, ties, and/or heated to bond by a melting process, or be attached to the existing mounting as used for conventional systems, etc., may suffice.

Lightbar 102 is preferably portable and lightweight permitting it to be removed or installed by any one user. Emergency lighting system 100 may also be mounted on at least one road block or other structural feature at a location. Handles on the lightbar 102 assist in the removal or installation of the lightbar 102 on the emergency vehicle 104 or on the structural support separate from the vehicle 104.

Referring now to FIG. 3, showing exploded view 300 illustrating emergency lighting system 100, according to a preferred embodiment of the present invention of FIG. 1. Emergency lighting system 100 preferably comprises at least one lightbar 102. Lightbar 102 preferably further comprises at least one housing 322; at least one LED 312, at least one solar panel 114, at least one rechargeable battery 116, at least one programmable chip 310, as shown. Lightbar 102 may also comprise means for audio transmission including speakers and the necessary wiring that may allow a user to sound at least one audio warning, a siren or other such audio command. In this manner warning device preferably comprises visual and/or audio signalers. Those with ordinary skill in the art will now appreciate that upon reading this specification and by their understanding the art of audio transmission means and necessary components as described herein, methods of audio transmission will be understood by those knowledgeable in such art.

Emergency lighting system 100 preferably comprises a single lightbar 102; however alternately preferably, more than one lightbar 102 may be used in combination with another lightbar 102. Another option is to use a plurality of lightbars 102 operating independently of one another using one or more remote control(s) 318. Preferably, remote control(s) 318 may also be operated remotely by an operator at a base station in the event an officer or ems is unable to operate their own remote control 318. Remote control 318 may require a coded input or other such suitable security means that deny anyone other than the officer to activate lightbar 102. Further, a means such as encrypting may be used to substantially ensure that other remote controllers aren'table to activate lightbar 102. Further options such as lightbar 102 may be activated when officer's gun or taser are withdrawn from their holsters. A camera located in lightbar 102 may also be activated to record the events as they unfold for later use as evidence.

Lightbar 102 preferably comprises housing 322 in which to mount rechargeable batteries 116, solar panels 114 and a plurality of LEDs 312. Lightbar 102 preferably comprises lightweight, rigid, durable material allowing a single user or multiple users to remove or install with relative ease.

Housing 322 preferably comprises lightweight, rigid, durable material and is preferably manufactured in at least one molding process to promote cost-effectiveness of such product. Housing 322 preferably comprises compartments such as those used to store wiring and rechargeable batteries 116 that are readily accessible and may be opened and/or closed to service components of lightbar 102. For example, solar panels 114 may be hinged to allow them to be moved according to relative sunlight position, and for removing and/or maintaining rechargeable batteries 116, or for servicing wiring or performing other such maintenance procedures. Opening and closing of lightbar 102 may be limited to authorized persons by having at least one coded communication that is sent via remote control 318, by the use of keyed locks or by using magnets or other such suitable securement means.

LEDs 312 may be preferably installed within at least one stationary block or alternately preferably, within at least one rotating mechanism located within housing 322. The stationary block design is preferred within the present invention because it is more economical with respect to power usage and because manufacturing is simplified since there are substantially no moving parts thereby also minimizing maintenance in use. LED 312 may be alternately turned on/off to give the visual effect of rotating, sequencing or moving lights to attract the attention of oncoming traffic and pedestrians, alerting them to potential dangers.

LEDs 312 are very power-efficient, compact, completely solid state, cost-effective to manufacture, and have no filaments to burn out, therefore provide a feasible, reliable lighting option within the preferred embodiment of the present invention. LED 312 may use at least one clear, colorless dome since the light color is an intrinsic property of the diodes themselves. Lightbars 102 can be made extremely thin according to the preferred embodiment of the present invention, because LEDs 312 may be manufactured extremely flat. This benefit provides a means to lower the profile thereby substantially limiting wind resistance experienced by lightbar 102 while emergency vehicle 104 is in motion.

LED 312 lights are preferably illuminated in a mode and/or flash pattern similar to that of strobe lights. LEDs 312 may be programmed to run a wide variety of flash patterns, to change colors, intensity and speed according to at least one user-preference, because of their ability to be switched directly by electronics. Those with ordinary skill in the art will now appreciate that upon reading this specification and by their understanding the art of LEDs as described herein, methods of use and manufacture of LEDs will be understood by those knowledgeable in such art.

Programmable chip 310 may be used within the present invention for controlling at least one LED 312. Those with ordinary skill in the art will now appreciate that upon reading this specification and by their understanding the art of programmable chips as described herein, methods of using and programming chips will be understood by those knowledgeable in such art.

Emergency vehicle 104 may use lightbar(s) 102 as at least one means to display programmed or non-programmed messages to other road users, indicating at least one special instruction such as to request other vehicles to pull over, by displaying a visual warning of an accident ahead or to display the name of the emergency service such as POLICE or FIRE. LED 312 may be used as a means of directing focused light to be used as a spotlight 324 from lightbar 102 or as a flash or supplemental light for a photoradar unit aimed in at least one preferred direction. Another embodiment of the present invention may comprise use of a remotely controlled camera for use in surveillance or other such suitable use.

Preferably, LEDs 102 provide a programmed direction-adjustable visual flash for use with at least one photoradar camera device. Spotlight 324 may be adjusted horizontally or vertically via at least one rotation of a pivotal member coupled to LEDs 312. This may also be accomplished by activating different LEDs 312 in different locations and orientations, including LEDs 312 that point upwardly on upper side of lightbar 102 and or LEDs 312 that point outwardly towards the sides of lightbar 102. This option may be very handy when searching down alleys or up/down embankments.

User may program and control lightbar 102 using remote control 318. Remote control 318 preferably comprises at least one set of alpha-numeric keys to allow such programming as well as on/off buttons, up/down, scroll and an adjustment control means to control the speed and/or direction and/or intensity of the light pulse/flash. Remote control 318 may also have at least one text displaying means whereby a user may read a communication or select a text. Upon reading this specification, those with ordinary skill in the art will now appreciate that, under appropriate circumstances, considering such issues as design preference, user preferences, marketing preferences, cost, structural requirements, available materials, technological advances, etc., other light directing means and arrangements such as, for example, rotatable/pivotable means to aim lights for spotlights 324 and/or camera flash means, alternate programming means such as computers, cellular telephones, pda' s, pagers, remotely programmed by a base station, other style buttons such as arrow keys to manipulate light direction, the remote control may also have an “officer down” or other such panic switch, and remote may turn on/off audio signals, etc., may suffice.

Emergency lighting system 100 may be preferably sold as at least one kit 340, preferably comprising the following parts: at least one lightbar 102; at least one LED 312; at least one solar panel 114; at least one rechargeable battery 116; at least one housing 322; at least one remote control 318; and at least one set of user instructions 350. User instructions 350 may comprise instructions for programming and controlling lightbar 102 using remote control 318 and provide information on warranties, maintenance and troubleshooting. Emergency lighting system 100 may be preferably manufactured and provided for sale in a wide variety of sizes and shapes, with a number of options for a wide assortment of vehicles and applications. Upon reading this specification, those with ordinary skill in the art will now appreciate that, under appropriate circumstances, considering such issues as design preference, user preferences, marketing preferences, cost, structural requirements, available materials, technological advances, etc., other kit contents or arrangements such as, for example, including more or less components, customized parts, and parts may be sold separately, etc., may be used.

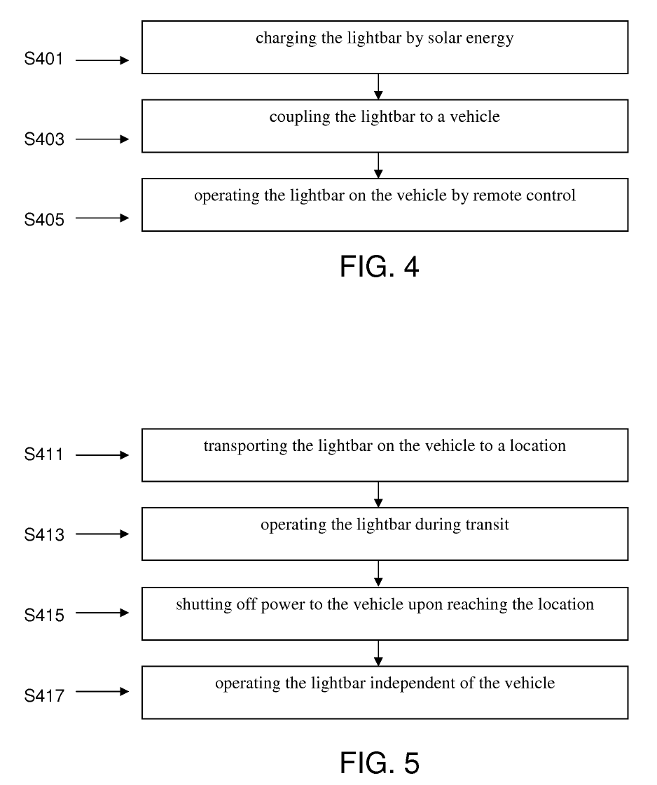

Referring now to FIG. 4, a method of use of the emergency lighting system 100 will now be explained. Prior to operating the emergency lighting system 100, including the lightbar 102, the rechargeable batteries 116 can be charged so as to be able to provide power to the system 100. The emergency lighting system 100 may be charged by solar energy, as shown in S401. Further, the emergency lighting system 100 may also be charged by solar energy while the emergency lighting system 100 is in use, or more particularly, while the lightbar 102 is in use. In fact, the emergency lighting system 100 is capable of recharging its rechargeable batteries 116 whenever the system 100 is out in the sun, whether the system 100, including the lightbar 102, is in operational use or not. Nevertheless, as an alternative to charging the rechargeable batteries 116 by solar energy, the emergency lighting system 100 may be charged by electrically coupling the system 100 to the power source of the vehicle 104, on which the emergency lighting system 100 is mounted, such that the power source of the vehicle 104 provides power to the system 100 and charges the rechargeable batteries 116.

As shown in S403, the emergency lighting system 100 is coupled to a vehicle 104 so that the emergency lighting system 100 may then be operated by the remote control 318, by a user from either inside or outside the vehicle 104 while the vehicle is stationary or in transit, S405. This provides the user an advantage over other lightbar devices without such a remote control, as the user with the remote control 318 can change the operation of the emergency lighting system 100 whether the user is inside the vehicle 104 or even if the user is temporarily away from the vehicle 104.

As shown in FIG. 5, and as mentioned briefly above, after the emergency lighting system 100 is coupled to the vehicle 104, the emergency lighting system 100 may be transported to a location where it, or the vehicle 104, is needed, S411. During transit to the location, the emergency lighting system 100 may be operated by the user, if needed or desired, depending on the circumstances in which the user finds himself/herself, S413.

Having arrived at the location, it is often times necessary to remain at the location for an extended period of time. It would be wasteful to require the vehicle 104 to remain powered on during this extended period in order to operate the emergency lighting system 100 that is mounted to the vehicle 104. Accordingly, the emergency lighting system 100 is capable of allowing the vehicle 104 to be powered down, S415, and yet still maintain the operation of the emergency lighting system 100 in its full capacity, S417. Indeed, an advantage of the present emergency lighting system 100 over other systems is that the operation of the emergency lighting system 100 may be independent of the operation of the vehicle 104 and the emergency lighting system 100 may be powered independently from the vehicle 104.

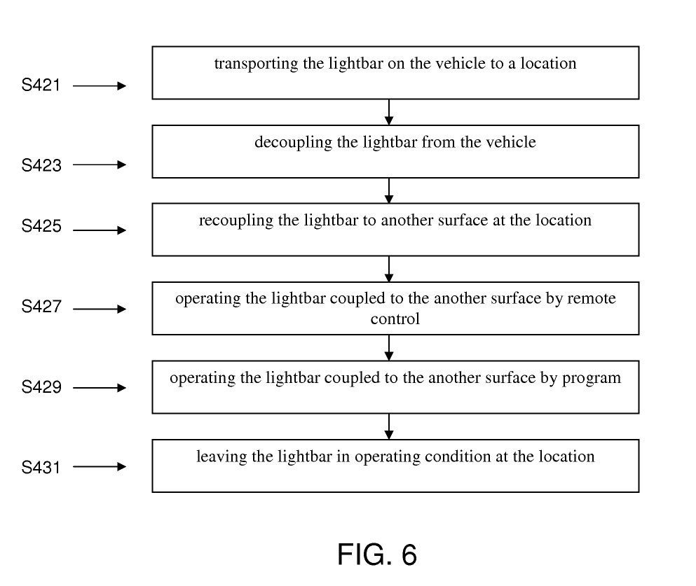

As shown in FIG. 6, the emergency lighting system 100 also provides another advantage. Once the emergency lighting system 100 is transported to a location, S421, the emergency lighting system 100 is capable of being decoupled from the vehicle 104 by a single user, S423. The emergency lighting system 100 is then recoupled to another surface at the location, S425, independent of the vehicle 104. While coupled to the another surface, the emergency lighting system 100 continues to operate at full capacity. The emergency lighting system 100 may function in response to input from the remote control 318 operated by the user, S427, or the emergency lighting system 100 may, for example, be programmed to permanently display a visual light and/or written message or to cycle through and repeat a series of visual lights and/or written messages, S429. Nevertheless, the emergency lighting system 100 continues to operate at full capacity for a relatively infinite length of time, because the operation of the emergency lighting system 100 is independent of the vehicle 104 and the power source of the emergency lighting system 100 being independent of the vehicle 104, i.e., the sun. Thus, once programmed, the emergency lighting system 100 may be left behind at the location, S431, to operate in its normal operating condition even after the vehicle 104 and the user have left the location.

It should be noted that the steps described in the method of use can be carried out in many different orders according to user preference. Upon reading this specification, those with ordinary skill in the art will now appreciate that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may suffice.

The embodiments of the invention described herein are exemplary and numerous modifications, variations and rearrangements can be readily envisioned to achieve substantially equivalent results, all of which are intended to be embraced within the spirit and scope of the invention.

What is claimed is:

1. A warning device comprising:
a lightbar having an LED;
a programmable chip within the lightbar for controlling the lightbar and the LED; and
a controller for controlling the programmable chip,
wherein the controller is wirelessly linked to the programmable chip.

2. The warning device of claim 1, wherein the controller is a remote control.

3. The warning device of claim 2, wherein the remote control further comprises alpha-numeric buttons, on/off buttons, up/down buttons, a display for displaying text, a panic button, and speed control buttons for controlling and programming the lightbar.

4. The warning device of claim 1, wherein the controller is a base station operator, the base station operator being located remotely from the warning device.

5. The warning device of claim 1, wherein the lightbar is programmed to provide visual and audio signals, the visual signals being one of a flashing-light, a written text, a flash, and a spotlight.

6. The warning device of claim 5, wherein the flash is a direction-adjustable visual flash and the spotlight is a direction-adjustable visual spotlight, the direction being adjusted by the controller.

7. The warning device of claim 6, wherein the direction is based on user-input from the controller or on a pre-programmed schedule, the direction being adjusted by activating specific combinations of a plurality of LEDs, the plurality of LEDs producing light that is variable in color, speed, and intensity according to input from the controller or the schedule.

8. The warning device of claim 1, wherein the lightbar further comprises:
a housing having a lower horizontal portion, an upper horizontal portion having a length and a width, and a side portion between the lower horizontal portion and the upper horizontal portion, the width of the upper horizontal portion being greater than the height of the side portion,
wherein the housing contains a rechargeable battery that powers the lightbar.

9. The warning device of claim 1, wherein the lightbar is structured to repeatedly removably couple to and detach from a vehicle.

10. A warning device of claim 1, further comprising:
a power source that powers the lightbar,
wherein the power source is a rechargeable battery and is contained entirely within the lightbar.

11. The warning device of claim 10, wherein the rechargeable battery is charged by a solar panel having solar cells.

12. The warning device of claim 11, wherein the solar panel is located on an upper-horizontal surface of the lightbar.

13. The warning device of claim 10, further comprising a plurality of solar panels for charging the rechargeable battery.

14. The warning device of claim 12, further comprising hinged portions in the upper-horizontal surface portion of the lightbar, wherein each of the plurality of solar panels is mounted flat to one of the hinged portions.

15. The warning device of claim 10, further comprising:
a plurality of rechargeable batteries that are each charged by a corresponding one of a plurality of solar panels having solar cells, wherein one of the rechargeable batteries powers the lightbar until its power is drained, whereupon another of the rechargeable batteries automatically powers the lightbar.

16. A vehicle having a lightbar, comprising:
the lightbar having an LED;
a programmable chip within the lightbar for controlling the lightbar and the LED;
a controller for controlling the programmable chip, the controller being wirelessly linked to the programmable chip; and
a power source that powers the lightbar, the power source being a rechargeable battery that is contained entirely within the lightbar, the rechargeable battery being charged by a solar panel having a solar cell,
the lightbar being structured to repeatedly removably couple to and detach from the vehicle.

17. The vehicle having the lightbar of claim 16, further comprising:
a housing having a lower horizontal portion, an upper horizontal portion having a length and a width, and a side portion between the lower horizontal portion and the upper horizontal portion, the width of the upper horizontal portion being greater than the height of the side portion; and
hinged portions in the upper horizontal portion,
wherein the housing contains the rechargeable battery, and the hinged portions have solar panels mounted thereto, the hinged portions being structured to open to reveal the rechargeable battery.

18. A method of using a warning device, comprising:
charging a lightbar by solar energy;
coupling the lightbar to a vehicle; and
operating the lightbar on the vehicle by remote control.

19. The method of claim 18, further comprising:
transporting the lightbar on the vehicle, after the coupling, to a location;
operating the lightbar by remote control during the transporting;
shutting off power to the vehicle after arriving at the location; and
continuing to operate the lightbar independent of the vehicle after the shutting off power to the vehicle.

20. The method of claim 18, further comprising:
transporting the lightbar on the vehicle, after the coupling, to a location;
decoupling the lightbar from the vehicle after arriving at the location;
recoupling the lightbar to a stationary surface at the location; and
operating the lightbar coupled to the stationary surface at the location.
